(19) United States
(12) Patent Application Publication
(10) Pub. No.: US 2022/0142846 A1
(43) Pub. Date: May 12, 2022

(54) SUCTION AID EQUIPMENT

(71) Applicant: Dentaluv Inc., Ansan-si, Gyeonggi-do (KR)

(72) Inventor: Jeong Hwa SONG, Seoul (KR)

(21) Appl. No.: 17/438,696

(22) PCT Filed: Jul. 16, 2020
(86) PCT No.: PCT/KR2020/009381

§ 371 Date: Sep. 13, 2021

(30) Foreign Application Priority Data
Feb. 19, 2020 (KR) 10-2020-0020425

(51) Int. Cl. A61G 15/16; A61C 17/06

(52) U.S. Cl. CPC A61G 15/16; A61C 17/06

(57) ABSTRACT

A suction aid equipment is proposed. The suction aid equipment includes a gripper configured to hold a suction module to be inserted in an oral cavity of a patient, an adjuster coupled to the gripper and configured to adjust a position of the suction module in the oral cavity of the patient, and a support configured to support the gripper and the adjuster from the ground. By this suction aid equipment, the dentist may perform dental treatment alone in a state in which the suction module is precisely fixed at a required position without the help of a nursing assistant.

### TECHNICAL FIELD

The present invention relates to a suction aid equipment, and more particularly, to a suction aid equipment that allows a dentist to perform dental treatment alone in a state in which a suction module is precisely fixed at a required position without the help of a nursing assistant.

### BACKGROUND ART

In a dental treatment, dental suction equipment is necessarily used to remove saliva, foreign matters, blood, and the like, which are generated in an oral cavity of a patient during the treatment process.

Such dental suction equipment is provided with a suction module in which a suction tip to be inserted into the oral cavity of the patient is detachably installed for replacement. During a typical dental treatment, in order to ensure that the suction tip is positioned at an appropriate position in the oral cavity of the patient while gripping the suction module by hand, a nursing assistant to assist a dentist is required.

However, as a scale of a dental clinic is smaller in recent years, a single-person dental clinic, in which only a dentist performs treatment without the help of a nursing assistant, has become an issue in the dental industry.

Meanwhile, in order to enable single-person dental treatment by the dentist alone, a task of the nursing assistant who helps the use of the suction module should be technically replaced by an appropriate aid means.

### SUMMARY OF INVENTION

### Problems to be Solved by Invention

Accordingly, it is an object of the present invention to provide suction aid equipment that allows a dentist to perform dental treatment alone in a state in which a suction module is precisely fixed at a required position without the help of a nursing assistant.

### Means for Solving Problems

To achieve the above object, according to an aspect of the present invention, there is provided a suction aid equipment including: a gripper configured to hold a suction module to be inserted in an oral cavity of a patient; and an adjuster coupled to the gripper and configured to adjust a position of the suction module in the oral cavity of the patient.

Preferably, the suction aid equipment further includes a support configured to support the gripper and the adjuster from a ground.

In addition, the adjuster may include a first adjuster whose one end is coupled to the support and the other end is coupled to an end of an adjustment link configured to adjust the position of the suction module in the oral cavity of the patient, and a second adjuster whose one end is coupled to the other end of the first adjuster, and the other end is coupled with the gripper.

### Advantageous Effects

According to the present invention, the dentist may perform dental treatment alone in a state in which the suction module is precisely fixed at a required position without the help of a nursing assistant.

### BRIEF DESCRIPTION OF DRAWINGS

FIG. 1 is a perspective view illustrating a structure of suction aid equipment according to an embodiment of the present invention;

FIG. 2 is an enlarged perspective view illustrating an installation structure of a first adjuster and a second adjuster shown in FIG. 1; and

FIG. 3 a perspective view illustrating a detailed structure of an adjustment link in the suction aid equipment according to an embodiment of the present invention.

### MODE FOR CARRYING OUT INVENTION

Hereinafter, the present invention will be described with reference to the accompanying drawings in detail. Referring to the drawings, like reference characters designate like or corresponding parts throughout the several views. In the embodiments of the present invention, the publicly known functions and configurations that are judged to make the purport of the present invention unnecessarily obscure will not be described.

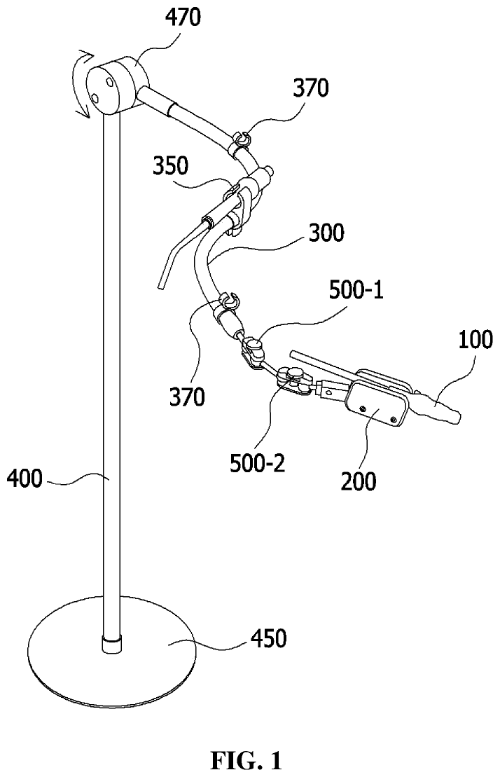

FIG. 1 is a perspective view illustrating a structure of suction aid equipment according to an embodiment of the present invention.

Referring to FIG. 1, the suction aid equipment according to an embodiment of the present invention includes a gripper 200, an adjustment link 300, a support 400, a first adjuster 500-1, and a second adjuster 500-2.

As shown in FIG. 1, the support 400, the adjustment link 300, the first adjuster 500-1, and the second adjuster 500-2 are continuously coupled, and the gripper 200 is coupled to an end of the second adjuster 500-2. The gripper 200 is configured to hold a suction module 100 inserted into an oral cavity of a patient in a clamp manner.

The support 400 is a rod-shaped member vertically installed to support the gripper 200 and the adjuster 500 from the ground. Herein, a pivot unit 470 is provided at an upper end of the support 400, and a fixed plate 450 for fixing the support 400 to the ground is provided at a lower end of the support 400.

The fixed plate 450 is a panel-shaped structure placed on the ground, and may be provided with transfer wheels or the like at a lower portion thereof to be moved and installed at a required position in the treatment room.

Meanwhile, it is preferable that such the fixed plate 450 is manufactured to have a weight enough to prevent the support 400 from being overturned by loads of the adjuster and the gripper 200.

The pivot unit 470 includes a pair of disc structures rotatably coupled to each other, and the adjustment link 300 is coupled to one disc structure among the pair of disc structures included in the pivot unit 470.

Meanwhile, as the disk structure to which the adjustment link 300 is coupled is independently rotatable while being coupled to other disk structure coupled to the upper end of the support, a user may control an installation direction of the adjustment link 300 as necessary.

The adjustment link 300 is a plastically deformable cable-type coil structure, of which one end is coupled to the pivot unit 470. The first adjuster 500-1 is installed at the other end of the adjustment link 300.

As the user may freely linearly bend the adjustment link 300, which is a plastically deformable cable-type coil structure, in a horizontal, vertical, or oblique direction, it is possible to fixedly install the suction module 100 held by the gripper 200 at the required position according to the medical situation.

Meanwhile, as shown in FIG. 1, a guide member 370 may be additionally installed on the adjustment link 300 to guide a suction hose (not shown) so as to be moved along the adjustment link 300 by fixing the suction hose thereto, which will be connected to the end of the suction module 100.

In addition, in implementing the present invention, when installing the suction hose by inserting it into the adjustment link 300, which is a cable-type coil structure, it is possible to prevent an occurrence of an obstacle to treatment due to the suction hose during adjusting the position thereof using the adjustment link 300, and an occurrence of an obstacle during treatment due to the suction hose.

That is, in implementing the present invention, the suction hose is inserted into the adjustment link 300, which is a cable-type coil structure, and then one end of the suction hose to be connected with the suction module 100 may be led out through a hole (not shown) formed on a side of the other end of the adjustment link 300.

In addition, in implementing the present invention, the suction hose inserted into the adjustment link 300 may pass through the inside of the support 400, and the other end of the suction hose to be connected with a suction device body may be led out to an outside through the fixed plate 450 provided under the support 400.

To this end, the support 400, which is a vertically installed rod-shaped member, has a cylindrical insertion space into which the suction hose is inserted formed therein in the vertical direction, and the cylindrical insertion space inside the support 400 may form a space continued to an installation space for the suction hose formed inside the adjustment link 300.

In addition, in implementing the present invention, the adjustment link 300 may have a holder 350 additionally installed thereon, on which an additional suction module waiting for the next use is held and mounted.

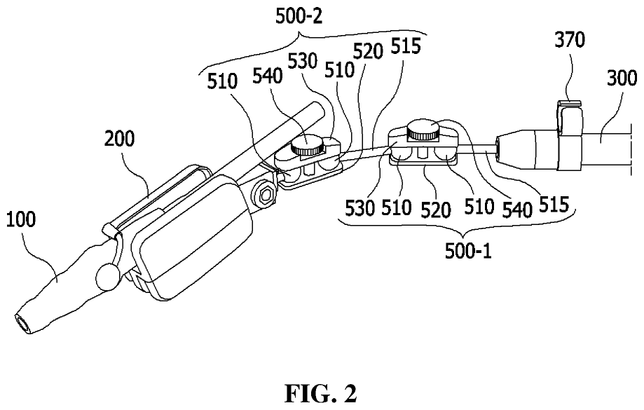

FIG. 2 is an enlarged perspective view illustrating an installation structure of a first adjuster 500-1 and a second adjuster 500-2 shown in FIG. 1. Referring to FIG. 2, the first adjuster 500-1 installed at the end of the adjustment link 300 includes a pair of ball structures 510, a lower plate 520, an upper plate 530, and a fixing member 540.

The respective ball structures 510 have connecting rods 515 formed thereon one by one to extend in directions opposite to each other. The connecting rod 515 provided in the ball structure 510 installed on a right side of the first adjuster 500-1 is coupled to the end of the adjustment link 300, and the connecting rod provided in the ball structure 510 installed on a left side of the first adjuster 500-1 is interconnected with the connecting rod 515 provided in the ball structure 510 installed on a right side of the second adjuster 500-2.

The lower plate 520 has a pair of concave grooves formed on an upper surface thereof, on which a pair of ball structures 510 are respectively seated, and the upper plate 530 has a pair of concave grooves formed on a lower surface thereof, on which a pair of ball structures 510 are seated and gripped, respectively.

Accordingly, the pair of ball structures 510 are rotatably installed in a space between the lower plate 520 and the upper plate 530 which are installed to face each other, like the structure of a ball bearing.

The fixing member 540 is installed to pass through the upper plate 530 from the upper surface of the upper plate 530, and a lower end of the fixing member 540 is fixed to the upper surface of the lower plate 520. At this time, the fixing member 540 is installed between the pair of ball structures 510.

In implementing the present invention, by manufacturing the fixing member 540 in a structure such as a bolt, the user may control a coupling strength in the first adjuster 500-1 of the ball structure 510 in a way that adjusts a degree of tightening of the fixing member 540.

Meanwhile, in implementing the present invention, as shown in FIG. 2, it is preferable that the upper plate 530 has an insertion space formed on the upper surface thereof, into which a bolt head of the fixing member 540 can be inserted, so that the bolt head of the fixing member 540 does not protrude from the upper surface of the upper plate 530.

Accordingly, the user may freely control the coupling angle and coupling direction of the pair of ball structures 510 provided in the first adjuster 500-1 along a three-dimensional spherical surface of the ball structure 510. As a result, it is possible to more precisely control the position of the suction module 100 held by the gripper 200.

In addition, the user may control the coupling strength of the ball structure 510 by adjusting a degree of rotation for coupling in the fixing member 540 by means such as a bolt. As a result, it is possible to maintain the coupling angle and coupling direction in the first adjuster 500-1 of the ball structure 510 controlled by the user despite the loads of the gripper 200 and suction module 100.

In addition, as shown in FIG. 2, the second adjuster 500-2 connected to the first adjuster 500-1 also includes a pair of ball structures 510, a lower plate 520, an upper plate 530 and a fixing member 540.

The respective ball structures 510 in the second adjuster 500-2 also have connecting rods 515 formed thereon one by one to extend in directions opposite to each other.

The connecting rod 515 provided in the ball structure 510 installed on the right side of the second adjuster 500-2 is interconnected with the connecting rod 515 provided in the ball structure 510 installed on the left side of the first adjuster 500-1, and the connecting rod provided in the ball structure 510 installed on the left side of the second adjuster 500-2 is coupled to the gripper 200.

The lower plate 520 in the second adjuster 500-2 also has a pair of concave grooves formed on an upper surface thereof, on which a pair of ball structures 510 are respectively seated, and the upper plate 530 in the second adjuster 500-2 also has a pair of concave grooves formed on a lower surface thereof, on which a pair of ball structures 510 are seated and gripped, respectively.

Accordingly, the pair of ball structures 510 are rotatably installed in a space between the lower plate 520 and the upper plate 530 which are installed to face each other, like the structure of a ball bearing.

The fixing member 540 in the second adjuster 500-2 is also installed to pass through the upper plate 530 from the upper surface of the upper plate 530, and a lower end of the fixing member 540 is fixed to the upper surface of the lower plate 520. At this time, the fixing member 540 is installed between the pair of ball structures 510.

In implementing the present invention, by manufacturing the fixing member 540 in the second adjuster 500-2 in a structure such as a bolt, the user may control a coupling strength in the second adjuster 500-2 of the ball structure 510 in a way that adjusts a degree of tightening of the fixing member 540.

Meanwhile, in implementing the present invention, as shown in FIG. 2, it is preferable that the upper plate 530 in the second adjuster 500-2 also has an insertion space formed on the upper surface thereof, into which a bolt head of the fixing member 540 can be inserted, so that the bolt head of the fixing member 540 does not protrude from the upper surface of the upper plate 530.

Accordingly, the user may freely control the coupling angle and coupling direction of the pair of ball structures 510 provided in the second adjuster 500-2 along the three-dimensional spherical surface of the ball structure 510. As a result, it is possible to more precisely control the position of the suction module 100 held by the gripper 200.

In addition, the user may control the coupling strength of the ball structure 510 by adjusting a degree of rotation for coupling in the fixing member 540 such as a bolt. As a result, it is possible to maintain the coupling angle and coupling direction in the second adjuster 500-2 of the ball structure 510 controlled by the user despite the loads of the gripper 200 and suction module 100.

As described above, the present invention allows the user to: firstly control the installation position of the suction module 100 through the adjustment link 300, which is a plastically deformable cable-type coil structure; secondary control the installation position of the suction module 100 by adjusting the coupling angle of the ball structure 510 installed on the right side of the first adjuster 500-1; thirdly control the installation position of the suction module 100 by adjusting the coupling angle of the ball structure 510 installed on the left side of the first adjuster 500-1; fourthly control the installation position of the suction module 100 by adjusting the coupling angle of the ball structure 510 installed on the right side of the second adjuster 500-2; and finally (fifthly) control the installation position of the suction module 100 by adjusting the coupling angle of the ball structure 510 installed on the left side of the second adjuster 500-2.

That is, according to the present invention, the user such as a dentist may perform dental treatment alone in a state in which the suction module 100 is precisely fixed at a required position without the help of a nursing assistant.

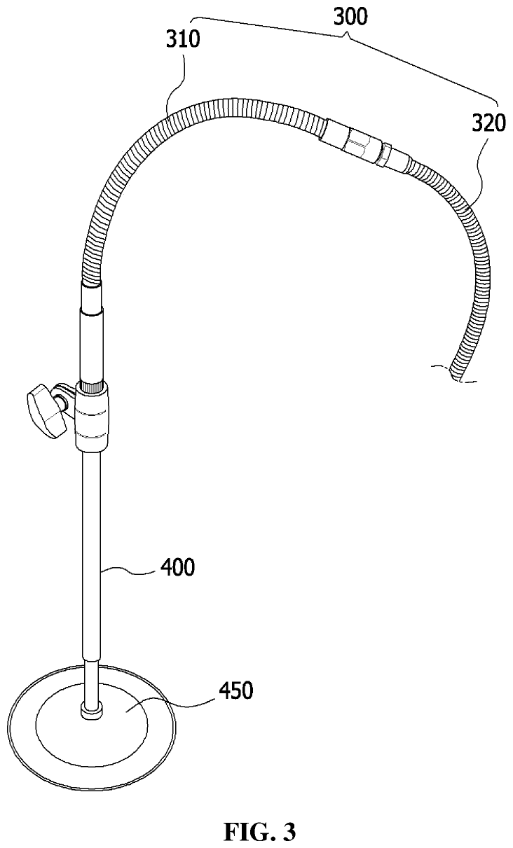

FIG. 3 a perspective view illustrating a detailed structure of the adjustment link 300 in the suction aid equipment according to an embodiment of the present invention. Referring to FIG. 3, the adjustment link 300 in the suction aid equipment according to an embodiment of the present invention includes a rigid part 310 and a flexible part 320.

The rigid part 310 is a rigid coil structure, of which one end is fixed to the pivot unit 470, and the flexible part 320 is a flexible coil structure whose one end is coupled to the other end of the rigid part 310 by a screwing method. The other end of the flexible part 320 is coupled with the first adjuster 500-1.

As described above, in implementing the present invention, it is preferable that a portion on a side of the adjustment link 300 to be connected with the pivot unit 470 does not require a relatively large amount of change in the direction and position, thereby it is formed as the rigid part 310 which is a rigid coil structure, and a portion on a side of the adjustment link 300 to be connected with the first adjuster 500-1 requires a relatively large amount of change in the direction and position depending on the medical environment, thereby it is formed as the flexible part 320 which is a flexible coil structure.

As a result, according to the differential rigidity structure of the adjustment link 300 as shown in FIG. 3, it is possible to simultaneously implement a function of a firm position fixation for the suction module 100 and a function of a flexible position adjustment for the suction module 100 at the same time.

Meanwhile, in implementing the present invention, the suction aid equipment according to the present invention may be used by directly coupling to a dental chair.

In this case, since the dental chair performs the function of the support 400, the suction aid equipment does not have the support 400 separately, and the adjustment link 300 may have a structure in which the end thereof is directly installed to the dental chair through a coupling member such as the pivot unit 470.

In addition, in implementing the present invention, by inserting a power supply line such as an electric wire into the adjustment link 300, the power supply to the medical lighting device further coupled to the adjustment link 300 may be made through the power supply line. There will be.

That is, in implementing the present invention, a power supply line is inserted into the adjustment link 300, which is a cable-type coil structure, and then one end of the power supply line to be connected with a medical lighting device may be exposed to an outside through a hole (not shown) formed on a side of the other end of the adjustment link 300.

In addition, in implementing the present invention, the power supply line inserted into the adjustment link 300 may pass through the inside of the support 400, and the other end of the power supply line may be led out to the outside through the fixed plate 450 provided under the support 400.

To this end, the support 400, which is a vertically installed rod-shaped member, has a cylindrical insertion space into which the power supply line is inserted formed therein in the vertical direction, and the cylindrical insertion space inside the support 400 may form a space continued to an installation space for the power supply line formed inside the adjustment link 300.

In addition, the terminology used herein is for the purpose of describing particular embodiments only and is not intended to limit the present invention thereto. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

While the present invention has been described with reference to the preferred embodiments and modified examples, the present invention is not limited to the above-described specific embodiments and the modified examples, and it will be understood by those skilled in the related art that various modifications and variations may be made therein without departing from the scope of the present invention as defined by the appended claims, as well as these modifications and variations should not be understood separately from the technical spirit and prospect of the present invention.

### INDUSTRIAL APPLICABILITY

The present invention may be applied to medical devices, such that industrial applicability thereof may be recognized in the medical device-related industrial field.

1. A suction aid equipment comprising:
a gripper configured to hold a suction module to be inserted in an oral cavity of a patient; and
an adjuster coupled to the gripper and configured to adjust a position of the suction module in the oral cavity of the patient.

2. The suction aid equipment according to claim 1, further comprising a support configured to support the gripper and the adjuster from a ground.

3. The suction aid equipment according to claim 2, the adjuster comprises a first adjuster whose one end is coupled to the support and the other end is coupled to an end of an adjustment link configured to adjust the position of the suction module in the oral cavity of the patient, and a second adjuster whose one end is coupled to the other end of the first adjuster, and the other end is coupled with the gripper.
